(19) United States
(12) Patent Application Publication
(10) Pub. No.: US 2021/0235255 A1
(43) Pub. Date: Jul. 29, 2021

(54) NEIGHBORHOOD AWARENESS NETWORKING (NAN) EXTENSION TO 6 GHZ OPERATION

(71) Applicant: QUALCOMM Incorporated, San Diego, CA (US)

(72) Inventors: Imran ANSARI, Hyderabad (IN); Rajeev Kumar SINGH, Hyderabad (IN); Sunit PUJARI, Hyderabad (IN)

(21) Appl. No.: 16/775,852

(22) Filed: Jan. 29, 2020

(51) Int. Cl. H04W 8/00; H04W 72/04; H04W 76/10

(52) U.S. Cl. CPC H04W 8/005; H04W 76/10; H04W 72/0453

(57) ABSTRACT

This disclosure provides methods, devices and systems for neighbor awareness networking extension to 6 GHz networks. A method is provided that may be performed by a wireless communication device. The wireless communication device discovers one or more peer devices in a neighborhood aware network (NAN) on a first radio frequency band. The wireless communication device discovers a capability of at least one of the one or more peer devices for communicating on a 6 GHz radio frequency band and/or publishes a capability of the wireless communication device for communicating on the 6 GHz radio frequency band. The wireless communication device establishes a NAN device link with the at least one peer device on the 6 GHz radio frequency band.

### TECHNICAL FIELD

This disclosure relates generally to wireless communication, and more specifically, to neighborhood awareness networking (NAN) extension to 6 GHz operation.

### DESCRIPTION OF THE RELATED TECHNOLOGY

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The deployment of wireless local area networks (WLANs, sometimes referred to as Wi-Fi networks) in the home, the office, and various public facilities is commonplace today. Such networks typically employ a wireless access point (AP) that connects a number of wireless stations (STAs) in a specific locality (such as the aforementioned home, office, public facility, etc.) to another network, such as the Internet or the like. A set of STAs can communicate with each other through a common AP in what is referred to as a basic service set (BSS).

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of WLAN air interface standards developed by the IEEE 802.11 committee for short-range communications (such as tens of meters to a few hundred meters).

A WLAN may be formed by one or more access points (APs) that provide a shared wireless communication medium for use by a number of client devices also referred to as stations (STAs). The basic building block of a WLAN conforming to the IEEE 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

A WLAN network may support Neighbor Awareness Networking (NAN). NAN may allow devices to find each other and communicate without an access point. For example, peer devices may connect without additional apps or configuration and share data at high speeds over the WLAN. NAN may not use Global Positioning System (GPS), cellular data, the Internet, or any other type of connectivity to establish and communicate over a data link. NAN is adopted in the Wi-Fi Alliance Wi-Fi Aware standards.

NAN (also referred to as Wi-Fi Aware networking), involves forming clusters of neighboring devices. NAN devices can discover other devices and create a bi-directional Wi-Fi Aware network connection without an AP.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. The method can be performed by a wireless communication device. The method generally includes discovering one or more peer devices in a neighborhood aware network (NAN) on a sub-6 GHz radio frequency band. The method generally includes discovering a capability of at least one of the one or more peer devices for communicating on a 6 GHz radio frequency band and/or publishing a capability of the wireless communication device for communicating on the 6 GHz radio frequency band. The method generally includes establishing a NAN device link with the at least one peer device on the 6 GHz radio frequency band.

Another innovative aspect of the subject matter described in this disclosure can be implemented in a wireless communication device. The wireless communication device includes at least one modem; at least one processor communicatively coupled with the at least one modem; and at least one memory communicatively coupled with the at least one processor and storing processor-readable code. The processor-readable code, when executed by the at least one processor in conjunction with the at least one modem, is configured to discover one or more peer devices in a NAN on a sub-6 GHz radio frequency band; discover a capability of at least one of the one or more peer devices for communicating on a 6 GHz radio frequency band and/or publish a capability of the wireless communication device for communicating on the 6 GHz radio frequency band; and establish a NAN device link with the at least one peer device on the 6 GHz radio frequency band.

In some implementations, the sub-6 GHz radio frequency band comprises a 2.4 GHz radio or a 5 GHz radio frequency band.

In some implementations, the methods and wireless communication devices may be configured to communicate directly with the at least one peer device over the NAN device link via the 6 GHz radio frequency band without an access point (AP).

In some implementations, the wireless communication device and the one or more peer devices comprises a NAN cluster having synchronized discovery windows.

In some implementations, the discovering the capability of the one or more peer devices comprises receiving a NAN service discovery management frame during a NAN discovery window; and the publishing the capability of the wireless communication device comprises multicasting a NAN service discovery management frame during the NAN discovery window.

In some implementations, the capability for communication on the 6 GHz radio frequency band is provided via one or more information elements (IEs) in the NAN service discovery management frame.

In some implementations, the establishing the NAN device link with the at least one peer device comprises establishing the NAN device link when the wireless communication device publishes capability for communicating on the 6 GHz radio frequency band and discovers the capability of the at least one peer device for communicating on the 6 GHz radio frequency band.

In some implementations, the methods and wireless communication devices may be configured to discover or publish one or more parameters associated with communicating on the 6 GHz radio frequency band.

In some implementations, the one or more parameters comprises at least one of: one or more supported operating classes or one or more supported channel numbers.

### BRIEF DESCRIPTION OF THE DRAWINGS

Details of one or more implementations of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 shows a pictorial diagram of an example wireless communication network.

FIG. 2 shows a pictorial diagram of another example wireless communication network.

FIG. 3 shows a block diagram of an example wireless communication device.

FIG. 4A shows a block diagram of an example access point (AP).

FIG. 4B shows a block diagram of an example station (STA).

FIG. 5 is an example call flow for extending neighborhood awareness networking (NAN) to 6 GHz operation according to some implementations.

FIG. 6 shows a flowchart illustrating an example process for NAN extension to 6 GHz operation according to some implementations.

FIG. 7 shows a block diagram of an example wireless communication device according to some implementations.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to neighbor awareness networking (NAN), also referred to as Wi-Fi Aware, and to 6 GHz operation. NAN allows NAN devices to discover each other establish data links, without the use of an access point (AP). 6 GHz operation allows increased throughput. Aspects of the disclosure provide for NAN extension to 6 GHz operation. In some implementations, NAN devices can discover each other's capability for 6 GHz operation during a NAN service discovery process. If the devices support 6 GHz, then a NAN device link (and NAN data path) can be established on a 6 GHz channel.

Particular implementations of the subject matter described in this disclosure can be implemented to realize one or more of the following potential advantages. In some implementations, the described techniques can be used to benefit from both NAN operation and 6 GHz operation for improved user experience. Thus, high throughput and low latency communications can be achieved between peer devices without the use of an AP. The high throughput can allow the device to exchange rich data, while the high throughput and low latency also results in power savings.

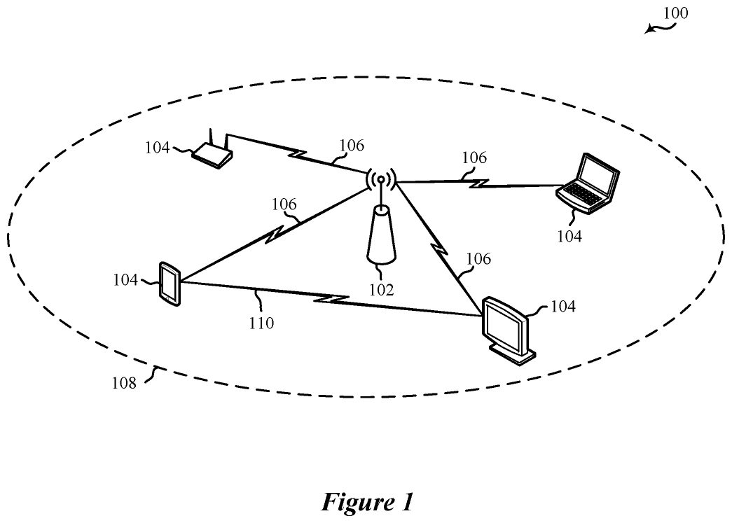

FIG. 1 shows a block diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). The wireless communication network 100 may include numerous wireless communication devices such as an access point (AP) 102 and multiple stations (STAs) 104. While only one AP 102 is shown, the wireless communication network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the wireless communication network 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the wireless communication network 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the wireless communication network 100. In such implementations, while the STAs 104 may be capable of communicating with each other through the AP 102 using communication links 108, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of physical layer convergence protocol (PLCP) protocol data units (PPDUs). The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PLCP service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

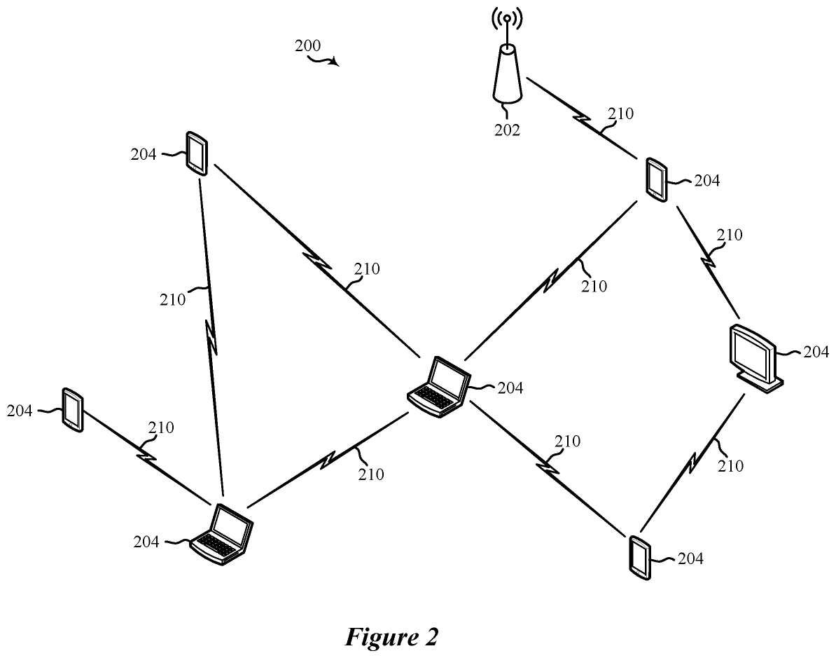

FIG. 2 shows a pictorial diagram of another example wireless communication network 200. According to some aspects, the wireless communication network 200 can be an example of a WLAN. For example, the wireless communication network 200 can be a network implementing at least one of the IEEE 802.11 family of standards. The wireless communication network 200 may include multiple STAs 204. As described above, each of the STAs 204 also may be referred to as a mobile station (MS), a mobile device, a mobile handset, a wireless handset, an access terminal (AT), a user equipment (UE), a subscriber station (SS), or a subscriber unit, among other possibilities. The STAs 204 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

The wireless communication network 200 is an example of a peer-to-peer (P2P), ad hoc or mesh network. STAs 204 can communicate directly with each other via P2P wireless links 210 (without the use of an intermediary AP). In some implementations, the wireless communication network 200 is an example of a neighbor awareness network (NAN). NANs operate in accordance with the Wi-Fi Alliance (WFA) Neighbor Awareness Networking (also referred to as NAN) standard specification. NAN-compliant STAs 204 (hereinafter also simply “NAN devices 204”) transmit and receive NAN communications (for example, in the form of Wi-Fi packets including frames conforming to an IEEE 802.11 wireless communication protocol standard such as that defined by the IEEE 802.11-2016 specification or amendments thereof including, but not limited to, 802.11ah, 802.11ad, 802.11ay, 802.11ax, 802.11az, 802.11ba and 802.11be) to and from one another via wireless P2P links 210 (hereinafter also referred to as “NAN links”) using a data packet routing protocol, such as Hybrid Wireless Mesh Protocol (HWMP), for path selection.

A NAN network generally refers to a collection of NAN devices that share a common set of NAN parameters including: the time period between consecutive discovery windows, the time duration of the discovery windows, the NAN beacon interval, and the NAN discovery channel(s). A NAN ID is an identifier signifying a specific set of NAN parameters for use within the NAN network. NAN networks are dynamically self-organized and self-configured. NAN devices 204 in the network automatically establish an ad-hoc network with other NAN devices 204 such that network connectivity can be maintained. Each NAN device 204 is configured to relay data for the NAN network such that various NAN devices 204 may cooperate in the distribution of data within the network. As a result, a message can be transmitted from a source NAN device to a destination NAN device by being propagated along a path, hopping from one NAN device to the next until the destination is reached.

Each NAN device 204 is configured to transmit two types of beacons: NAN discovery beacons and NAN synchronization beacons. When a NAN device 204 is turned on, or otherwise when NAN-functionality is enabled, the NAN device periodically transmits NAN discovery beacons (for example, every 100 TUs, every 128 TUs or another suitable period) and NAN synchronization beacons (for example, every 512 TUs or another suitable period). Discovery beacons are management frames, transmitted between discovery windows, used to facilitate the discovery of NAN clusters. A NAN cluster is a collection of NAN devices within a NAN network that are synchronized to the same clock and discovery window schedule using a time synchronization function (TSF). To join NAN clusters, NAN devices 204 passively scan for discovery beacons from other NAN devices. When two NAN devices 204 come within a transmission range of one another, they will discover each other based on such discovery beacons. Respective master preference values determine which of the NAN devices 204 will become the master device. If a NAN cluster is not discovered, a NAN device 204 may start a new NAN cluster. When a NAN device 204 starts a NAN cluster, it assumes the master role and broadcasts a discovery beacon. Additionally, a NAN device may choose to participate in more than one NAN cluster within a NAN network.

The links between the NAN devices 204 in a NAN cluster are associated with discovery windows—the times and channel on which the NAN devices converge. At the beginning of each discovery window, one or more NAN devices 204 may transmit a NAN synchronization beacon, which is a management frame used to synchronize the timing of the NAN devices within the NAN cluster to that of the master device. The NAN devices 204 may then transmit multicast or unicast NAN service discovery frames directly to other NAN devices within the service discovery threshold and in the same NAN cluster during the discovery window. The service discovery frames indicate services supported by the respective NAN devices 204.

In some instances, NAN devices 204 may exchange service discovery frames to ascertain whether both devices support ranging operations. NAN devices 204 may perform such ranging operations (“ranging”) during the discovery windows. The ranging may involve an exchange of fine timing measurement (FTM) frames (such as those defined in IEEE 802.11-REVmc). For example, a first NAN device 204 may transmit unicast FTM requests to multiple peer NAN devices 204. The peer NAN devices 204 may then transmit responses to the first NAN device 204. The first NAN device 204 may then exchange a number of FTM frames with each of the peer NAN devices 204. The first NAN device 204 may then determine a range between itself and each of the peer NAN devices 204 based on the FTM frames and transmit a range indication to each of the peer NAN devices 204. For example, the range indication may include a distance value or an indication as to whether a peer NAN device 204 is within a service discovery threshold (for example, 3 meters (m)) of the first NAN device 204. NAN links between NAN devices within the same NAN cluster may persist over multiple discovery windows as long as the NAN devices remain within the service discovery thresholds of one another and synchronized to the anchor master of the NAN cluster.

Some NAN devices 204 also may be configured for wireless communication with other networks such as with a Wi-Fi WLAN or a wireless (for example, cellular) wide area network (WWAN), which may, in turn, provide access to external networks including the Internet. For example, a NAN device 204 may be configured to associate and communicate, via a Wi-Fi or cellular link 212, with an AP or base station 202 of a WLAN or WWAN network, respectively. In such instances, the NAN device 204 may include software-enabled access point (SoftAP) functionality enabling the STA to operate as a Wi-Fi hotspot to provide other NAN devices 204 with access to the external networks via the associated WLAN or WWAN backhaul. Such a NAN device 204 (referred to as a NAN concurrent device) is capable of operating in both a NAN network as well as another type of wireless network, such as a Wi-Fi BSS. In some such implementations, a NAN device 204 may, in a service discovery frame, advertise an ability to provide such access point services to other NAN devices 204.

There are two general NAN service discovery messages: publish messages and subscribe messages. Generally, publishing is a mechanism for an application on a NAN device to make selected information about the capabilities and services of the NAN device available to other NAN devices, while subscribing is a mechanism for an application on a NAN device to gather selected types of information about the capabilities and services of other NAN devices. A NAN device may generate and transmit a subscribe message when requesting other NAN devices operating within the same NAN cluster to provide a specific service. For example, in an active subscriber mode, a subscribe function executing within the NAN device may transmit a NAN service discovery frame to actively seek the availability of specific services. A publish function executing within a publishing NAN device capable of providing a requested service may, for example, transmit a publish message to reply to the subscribing NAN device responsive to the satisfaction of criteria specified in the subscribe message. The publish message may include a range parameter indicating the service discovery threshold, which represents the maximum distance at which a subscribing NAN device can avail itself of the services of the publishing NAN device. A NAN also may use a publish message in an unsolicited manner, for example, a publishing NAN device may generate and transmit a publish message to make its services discoverable for other NAN devices operating within the same NAN cluster. In a passive subscriber mode, the subscribe function does not initiate the transfer of any subscribe message, rather, the subscribe function looks for matches in received publish messages to determine the availability of desired services.

Subsequent to a discovery window is a transmission opportunity period. This period includes numerous resource blocks. A NAN device link (NDL) refers to the negotiated resource blocks between NAN devices used for NAN operations. An NDL can include more than one “hop.” The number of hops depends on the number of devices between the device providing the service and the device consuming or subscribing to the service. An example of an NDL that includes two hops includes three NAN devices: the provider, the subscriber, and a proxy to relay the information between the provider and the subscriber. In such a configuration, the first hop refers to the communication of information between the provider and the proxy, and the second hop refers to the communication of the information between the proxy and the subscriber. An NDL may refer to a subset of NAN devices capable of one-hop service discovery, but an NDL also may be capable of service discovery and subscription over multiple hops (a multi-hop NDL).

There are two general NDL types: paged NDL (P-NDL) and synchronized NDL (S-NDL). Each common resource block (CRB) of a P-NDL includes a paging window (PW) followed by a transmission window (TxW). All NAN devices participating in a P-NDL operate in a state to receive frames during the paging window. Generally, the participating NAN devices wake up during the paging window to listen on the paging channel to determine whether there is any traffic buffered for the respective devices. For example, a NAN device that has pending data for transmission to another NAN device may transmit a traffic announcement message to the other NAN device during the paging window to inform the other NAN device of the buffered data. If there is data available, the NAN device remains awake during the transmission window to exchange the data. If there is no data to send, the NAN device may transition back to a sleep state during the transmission window to conserve power. A NAN device transmits a paging message to its NDL peer during a paging window if it has buffered data available for the peer. The paging message includes, for example, the MAC addresses or identifiers of the destination devices for which data is available. A NAN device that is listed as a recipient in a received paging message transmits a trigger frame to the transmitting device and remains awake during the subsequent transmission window to receive the data. The NDL transmitter device transmits the buffered data during the transmission window to the recipient devices from whom it received a trigger frame. A NAN device that establishes an S-NDL with a peer NAN device may transmit data frames to the peer from the beginning of each S-NDL CRB without transmitting a paging message in advance.

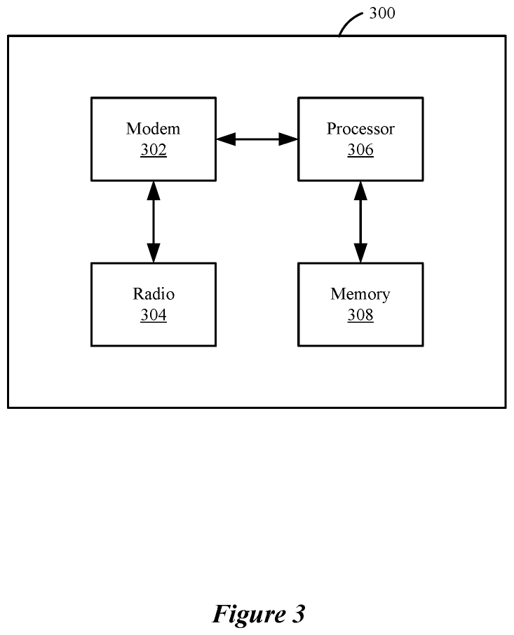

FIG. 3 shows a block diagram of an example wireless communication device 300. In some implementations, the wireless communication device 300 can be an example of a device for use in a STA such as one of the STAs 104 described above with reference to FIG. 1. In some implementations, the wireless communication device 300 can be an example of a device for use in an AP such as the AP 102 described above with reference to FIG. 1. The wireless communication device 300 is capable of transmitting (or outputting for transmission) and receiving wireless communications (for example, in the form of wireless packets). For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 300 can be, or can include, a chip, system on chip (SoC), chipset, package, or device that includes one or more modems 302, for example, a Wi-Fi (IEEE 802.11 compliant) modem. In some implementations, the one or more modems 302 (collectively “the modem 302”) additionally include a WWAN modem (for example, a 3GPP 4G LTE or 5G compliant modem). In some implementations, the wireless communication device 300 also includes one or more radios 304 (collectively “the radio 304”). In some implementations, the wireless communication device 306 further includes one or more processors, processing blocks, or processing elements 306 (collectively “the processor 306”) and one or more memory blocks or elements 308 (collectively “the memory 308”).

The modem 302 can include an intelligent hardware block or device such as, for example, an application-specific integrated circuit (ASIC) among other possibilities. The modem 302 is generally configured to implement a PHY layer. For example, the modem 302 is configured to modulate packets and to output the modulated packets to the radio 304 for transmission over the wireless medium. The modem 302 is similarly configured to obtain modulated packets received by the radio 304 and to demodulate the packets to provide demodulated packets. In addition to a modulator and a demodulator, the modem 302 may further include digital signal processing (DSP) circuitry, automatic gain control (AGC), a coder, a decoder, a multiplexer and a demultiplexer. For example, while in a transmission mode, data obtained from the processor 306 is provided to a coder, which encodes the data to provide encoded bits. The encoded bits are then mapped to points in a modulation constellation (using a selected modulation and coding scheme (MCS)) to provide modulated symbols. The modulated symbols may then be mapped to a number Nss of spatial streams or a number Nsrs of space-time streams. The modulated symbols in the respective spatial or space-time streams may then be multiplexed, transformed via an inverse fast Fourier transform (IFFT) block, and subsequently provided to the DSP circuitry for Tx windowing and filtering. The digital signals may then be provided to a digital-to-analog converter (DAC). The resultant analog signals may then be provided to a frequency upconverter, and ultimately, the radio 304. In implementations involving beamforming, the modulated symbols in the respective spatial streams are precoded via a steering matrix prior to their provision to the IFFT block.

While in a reception mode, digital signals received from the radio 304 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for in-phase and quadrature (I/Q) imbalance), and applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are then fed to the demultiplexer for demultiplexing. The demultiplexed bits may then be descrambled and provided to the MAC layer (the processor 306) for processing, evaluation or interpretation.

The radio 304 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 300 can include, or be coupled with, multiple transmit antennas (each with a corresponding transmit chain) and multiple receive antennas (each with a corresponding receive chain). The symbols output from the modem 302 are provided to the radio 304, which then transmits the symbols via the coupled antennas. Similarly, symbols received via the antennas are obtained by the radio 304, which then provides the symbols to the modem 302.

The processor 306 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 306 processes information received through the radio 304 and the modem 302, and processes information to be output through the modem 302 and the radio 304 for transmission through the wireless medium. For example, the processor 306 may implement a control plane and MAC layer configured to perform various operations related to the generation and transmission of MPDUs, frames or packets. The MAC layer is configured to perform or facilitate the coding and decoding of frames, spatial multiplexing, space-time block coding (STBC), beamforming, and OFDMA resource allocation, among other operations or techniques. In some implementations, the processor 306 may generally control the modem 302 to cause the modem to perform various operations described above.

The memory 308 can include tangible storage media such as random-access memory (RAM) or read-only memory (ROM), or combinations thereof. The memory 308 also can store non-transitory processor- or computer-executable software (SW) code containing instructions that, when executed by the processor 306, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

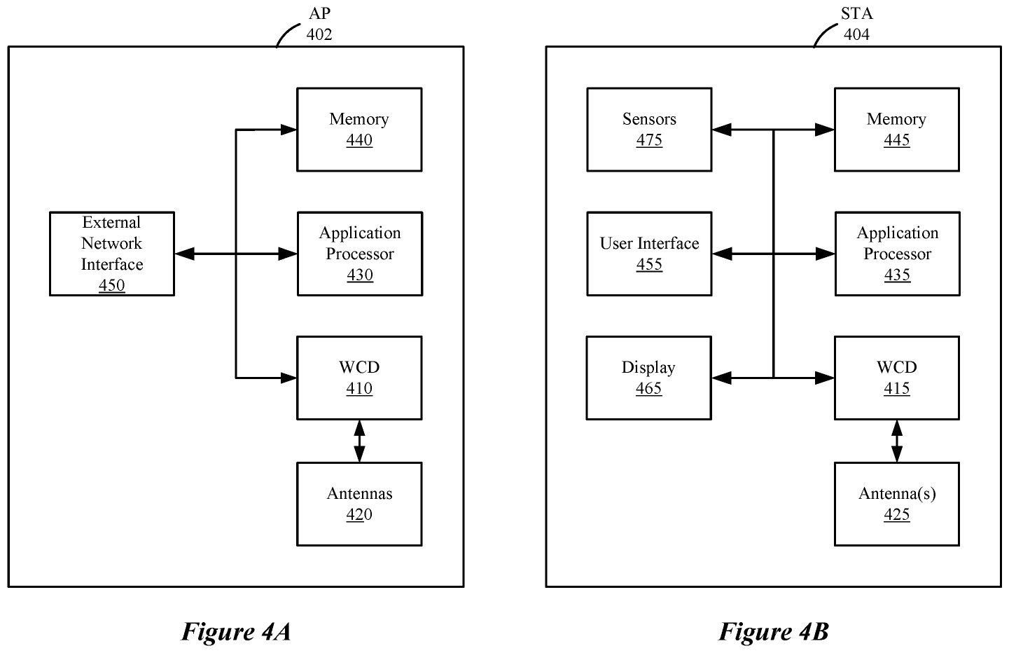

FIG. 4A shows a block diagram of an example AP 402. For example, the AP 402 can be an example implementation of the AP 102 described with reference to FIG. 1. The AP 402 includes a wireless communication device (WCD) 410 (although the AP 402 may itself also be referred to generally as a wireless communication device as used herein). For example, the wireless communication device 410 may be an example implementation of the wireless communication device 300 described with reference to FIG. 3. The AP 402 also includes multiple antennas 420 coupled with the wireless communication device 410 to transmit and receive wireless communications. In some implementations, the AP 402 additionally includes an application processor 430 coupled with the wireless communication device 410, and a memory 440 coupled with the application processor 430. The AP 402 further includes at least one external network interface 450 that enables the AP 402 to communicate with a core network or backhaul network to gain access to external networks including the Internet. For example, the external network interface 450 may include one or both of a wired (for example, Ethernet) network interface and a wireless network interface (such as a WWAN interface). Ones of the aforementioned components can communicate with other ones of the components directly or indirectly, over at least one bus. The AP 402 further includes a housing that encompasses the wireless communication device 410, the application processor 430, the memory 440, and at least portions of the antennas 420 and external network interface 450.

FIG. 4B shows a block diagram of an example STA 404. For example, the STA 404 can be an example implementation of the STA 104 described with reference to FIG. 1. The STA 404 includes a wireless communication device 415 (although the STA 404 may itself also be referred to generally as a wireless communication device as used herein). For example, the wireless communication device 415 may be an example implementation of the wireless communication device 300 described with reference to FIG. 3. The STA 404 also includes one or more antennas 425 coupled with the wireless communication device 415 to transmit and receive wireless communications. The STA 404 additionally includes an application processor 435 coupled with the wireless communication device 415, and a memory 445 coupled with the application processor 435. In some implementations, the STA 404 further includes a user interface (UI) 455 (such as a touchscreen or keypad) and a display 465, which may be integrated with the UI 455 to form a touchscreen display. In some implementations, the STA 404 may further include one or more sensors 475 such as, for example, one or more inertial sensors, accelerometers, temperature sensors, pressure sensors, or altitude sensors. Ones of the aforementioned components can communicate with other ones of the components directly or indirectly, over at least one bus. The STA 404 further includes a housing that encompasses the wireless communication device 415, the application processor 435, the memory 445, and at least portions of the antennas 425, UI 455, and display 465.

As described above, a wireless communication network may be configured as a NAN (such as the wireless communication network 200) and NAN-compliant STAs (such as the NAN devices 204) may transmit and receive NAN communications in the form of Wi-Fi packets including frames conforming to an IEEE 802.11 wireless communication protocol standard.

In certain systems (such as systems operation according to the current NAN specification), NAN devices may begin operation using an available 2.4 GHz and/or 5 GHz radio to establish a data link. In some cases, however, 6 GHz operation may be available (for example, supported by the NAN devices). For example, certain WLAN systems (such as IEEE 802.11ax Draft 4.0 and beyond) include support 6 GHz operation.

Therefore, techniques and apparatus for extending NAN operation to 6 GHz are desirable.

### Example NAN Extension to 6 GHz Operation

Various implementations relate generally to neighbor awareness networking (NAN), also referred to as Wi-Fi Aware, and to 6 GHz operation. NAN allows NAN devices to discover each other and establish data links, without the use of an access point (AP). 6 GHz operation allows increased throughput. Aspects of the disclosure provide for NAN extension to 6 GHz operation. In some implementations, NAN devices can discover each other's capability for 6 GHz operation during a NAN service discovery process. If the devices support 6 GHz, then a NAN device link (and NAN data path) can be established on a 6 GHz channel.

Particular implementations of the subject matter described in this disclosure can be implemented to realize one or more of the following potential advantages. In some implementations, the described techniques can be used to benefit from both NAN operation and 6 GHz operation for improved user experience. Thus, high throughput and low latency communications can be achieved between peer devices without the use of an AP. The high throughput can allow the device to exchange rich data, while the high throughput and low latency also results in power savings.

According to certain aspects, NAN devices may discover each other's capability for 6 GHz operation and for a NAN device link (NDL), and/or NAN data path (NDP), if the NAN devices support 6 GHz operation.

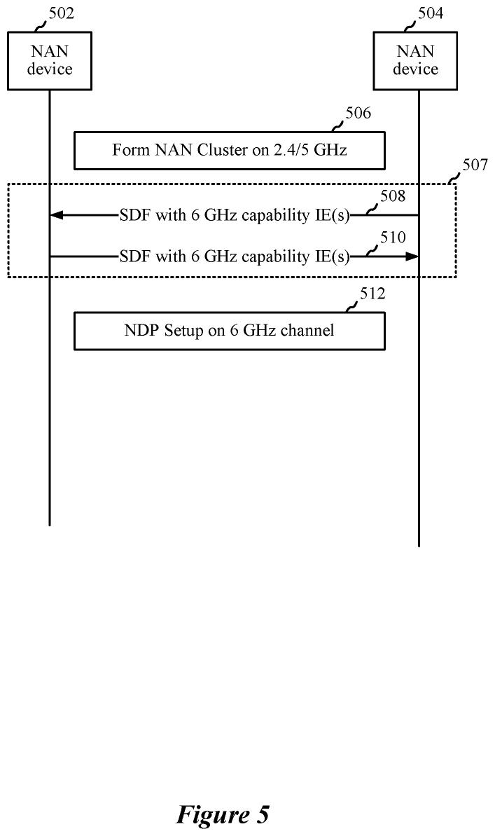

FIG. 5 is an example call flow for a process 500 for extending NAN to 6 GHz operation, in accordance with aspects of the present disclosure. As shown in FIG. 5, at 506, a NAN device 502 and a NAN device 504 may form a NAN cluster. A NAN cluster refers to a collection of NAN devices that are synchronized to a same NAN discovery window schedule. The NAN discovery window may be a time and channel on which NAN devices converge. The NAN devices may also be referred to as NAN peers. Although two NAN devices are shown in FIG. 5, different numbers of NAN peers can form a NAN cluster. In some examples, the NAN devices transmit beacon management frames outside of NAN discovery windows to facilitate discovery of NAN clusters. As discussed above with respect to FIG. 2, a NAN network may include a collection of NAN clusters that share a NAN ID (for example a medium access control (MAC) address) associated with a set of NAN parameters (such as time period between consecutive NAN discovery windows, time duration of NAN discovery windows, beacon interval, and NAN discovery channel(s)).

As shown in FIG. 5, the formation of the NAN cluster at 506 and synchronization of the NAN discovery window may be on a first channel, such as a 2.4 GHz or 5 GHz channel.

After formation of the NAN cluster, the NAN devices 502 and 504 can discovery each other's capabilities during a service discovery procedure at 507. In some examples, during the service discovery procedure at 507, the NAN devices 502 and 504 may send multicast and/or unicast NAN service discovery frames (SDFs) directly to other NAN devices within range in the same NAN cluster during the discovery window. The NAN SDFs may include the NAN network ID. As discussed above with respect to FIG. 2, the NAN SDFs may include publish and/or subscribe messages. The NAN SDFs may indicate NAN attributes associated with the NAN device that sends the NAN SDF. The NAN SDFs may include one or more NAN information elements (IEs) that indicate NAN attributes. The NAN SDFs may be action frames (for example, vendor specific public action frames). For example, the NAN SDFs may indicate one or more of the NAN attributes defined in Section 9 of the NAN Specification Version 3.0.

According to aspects of the present disclosure, new NAN attributes may be defined for NAN devices to indicate their capability for 6 GHz operation or parameters associated with the 6 GHz operation. As shown in FIG. 5, the service discovery procedure at 507 can include the NAN device 502 and 504 sending SDFs with 6 GHz capability IEs at 508 and 510, respectively.

Thus, at 512, the NAN devices 502 and 504 can establish an NDL/NDP on the 6 GHz channel when the NAN devices 502 and 504 both indicate their capability for 6 GHz operation. If the NAN devices 502 and 504 are not both capable of 6 GHz operation, then the link may continue on the 2.4 GHz or 5 GHz band.

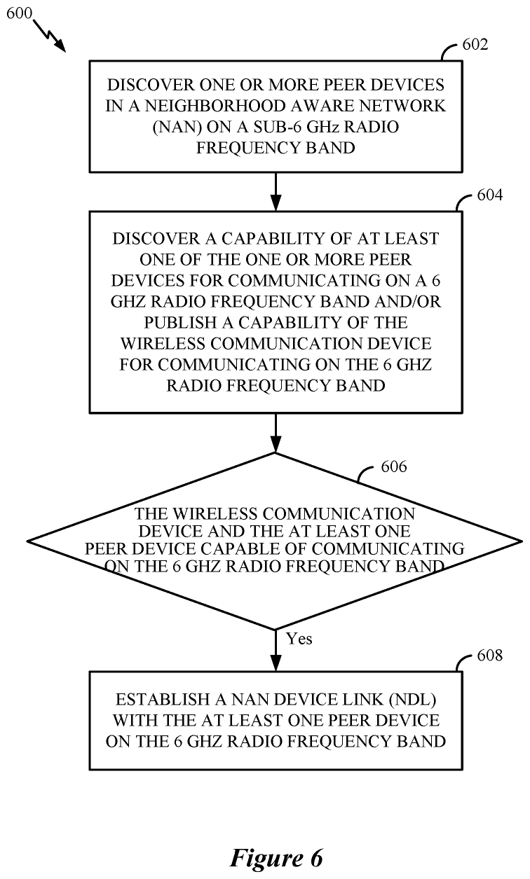

FIG. 6 shows a flowchart illustrating an example process 600 for NAN extension to 6 GHz operation according to some implementations. The operations of process 600 may be implemented by a wireless communication device or its components as described herein. For example, the process 600 may be performed by a wireless communication device such as the wireless communication device 300 described above with reference to FIG. 3. In some implementations, the process 600 may be performed by an STA, such as one of the STAs 104, 204, and 404 described above with reference to FIGS. 1, 2, and 4B, respectively.

In some implementations, in block 602, the wireless communication device discovers one or more peer devices in a NAN on a sub-6 GHz radio frequency band. In block 604, the wireless communication device discovers a capability of at least one of the one or more peer devices for communicating on a 6 GHz radio frequency band and/or publishes a capability of the wireless communication device for communicating on the 6 GHz radio frequency band. In block 606, the wireless communication device determines whether the wireless communication device and the at least one peer device are capable of communicating on the 6 GHz radio frequency band. If so, then in block 608, the wireless communication device establishes a NDL with the at least one peer device on the 6 GHz radio frequency band.

In some implementations, the sub-6 GHz radio frequency band is the 2.4 GHz or 5 GHz radio frequency band.

In some implementations, the discovery of the one or more peer devices in block 602 includes sending and/or receiving beacon management frames outside of NAN discovery windows. The wireless communication device and the one or more peer devices can form a NAN cluster having synchronized discovery windows.

In some implementations, the discovery and/or publishing of capability for communicating on the 6 GHz radio frequency band in block 604 includes receiving a NAN service discovery management frame during a NAN discovery window and/or multicasting a NAN service discovery management frame during the NAN discovery window. The capability for communication on the 6 GHz radio frequency band can be provided via one or more IEs in the NAN service discovery management frame (indicating new NAN attribute(s) for 6 GHz operation). The wireless communication device can discover and/or publish one or more parameters associated with communicating on the 6 GHz radio frequency band. The one or more parameters can include one or more supported operating classes and/or one or more supported channel numbers.

In some implementations, the establishing the NDL in block 608 includes establishing the NAN device link when the wireless communication device publishes capability for communicating on the 6 GHz radio frequency band and discovers the capability of the at least one peer device for communicating on the 6 GHz radio frequency band. The wireless communication device can communicate directly with the at least one peer device over the NDL via the 6 GHz radio frequency band without an AP. If the wireless communication device or the at least one peer device is not capable of 6 GHz operation, then the NDL may be maintained over the sub-6 GHz radio frequency band.

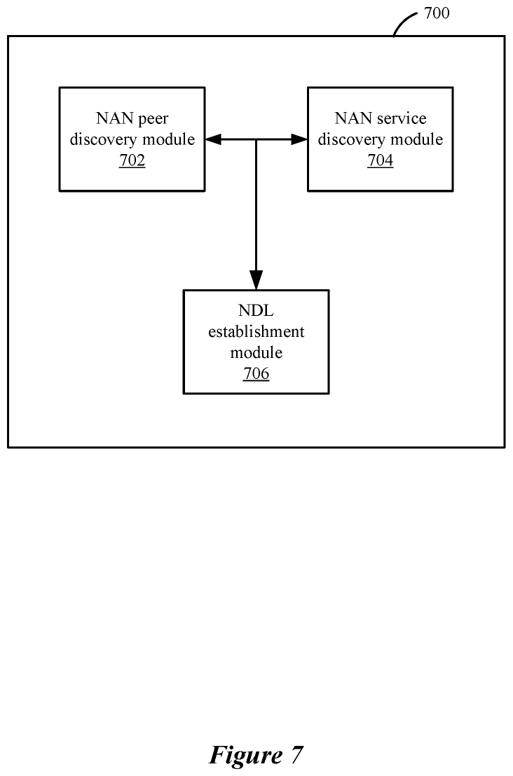

FIG. 7 shows a block diagram of an example wireless communication device 700 according to some implementations. In some implementations, the wireless communication device 700 is configured to perform one or more of the processes 500 and 600 described above with reference to FIGS. 5 and 6, respectively. The wireless communication device 700 may be an example implementation of the wireless communication device 300 described above with reference to FIG. 3. For example, the wireless communication device 700 can be a chip, SoC, chipset, package or device that includes at least one processor and at least one modem (for example, a Wi-Fi (IEEE 802.11) modem or a cellular modem). In some implementations, the wireless communication device 700 can be a device for use in a STA, such as one of the STAs 104, 204, and 404 described above with reference to FIGS. 1, 2, and 4B, respectively. In some other implementations, the wireless communication device SSSOO can be a STA that includes such a chip, SoC, chipset, package or device as well as at least one transmitter, at least one receiver, and at least one antenna.

The wireless communication device 700 includes a NAN peer discovery module 702, a NAN service discovery module 704, and a NDL establishment module 706. Portions of one or more of the modules 702, 704, and 706 may be implemented at least in part in hardware or firmware. For example, the modules 702, 704, and 706 may be implemented at least in part by a modem (such as the modem 302). In some implementations, at least some of the modules 702, 704, and 706 are implemented at least in part as software stored in a memory (such as the memory 308). For example, portions of one or more of the modules 702, 704, and 706 can be implemented as non-transitory instructions (or “code”) executable by a processor (such as the processor 306) to perform the functions or operations of the respective module.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication by a wireless communication device, comprising:
discovering one or more peer devices in a neighborhood aware network (NAN) on a sub-6 GHz radio frequency band;
at least one of: discovering a capability of at least one of the one or more peer devices for communicating on a 6 GHz radio frequency band or publishing a capability of the wireless communication device for communicating on the 6 GHz radio frequency band; and
establishing a NAN device link with the at least one peer device on the 6 GHz radio frequency band.

2. The method of claim 1, wherein the sub-6 GHz radio frequency band comprises a 2.4 GHz radio frequency band or a 5 GHz radio frequency band.

3. The method of claim 1, further comprising communicating directly with the at least one peer device over the NAN device link via the 6 GHz radio frequency band without an access point (AP).

4. The method of claim 1, wherein the wireless communication device and the one or more peer devices comprise a NAN cluster having synchronized discovery windows.

5. The method of claim 1, wherein:
the discovering the capability of the at least one of the one or more peer devices comprises receiving a NAN service discovery management frame during a NAN discovery window; and
the publishing the capability of the wireless communication device comprises multicasting a NAN service discovery management frame during the NAN discovery window.

6. The method of claim 5, wherein:
the discovering the capability of the at least one of the one or more peer devices is via one or more information elements (IEs) in the NAN service discovery management frame; and
the publishing the capability of the wireless communication device is via one or more IEs in the NAN service discovery management frame.

7. The method of claim 5, wherein the establishing the NAN device link with the at least one peer device comprises establishing the NAN device link when the wireless communication device publishes the capability of the wireless communication device for communicating on the 6 GHz radio frequency band and discovers the capability of the at least one peer device for communicating on the 6 GHz radio frequency band.

8. The method of claim 1, further comprising at least one of discovering or publishing one or more parameters associated with communicating on the 6 GHz radio frequency band.

9. The method of claim 8, wherein the one or more parameters comprise at least one of: one or more supported operating classes or one or more supported channel numbers.

10. A wireless communication device comprising:
at least one modem;
at least one processor communicatively coupled with the at least one modem; and
at least one memory communicatively coupled with the at least one processor and storing processor-readable code that, when executed by the at least one processor in conjunction with the at least one modem, is to:
discover one or more peer devices in a neighborhood aware network (NAN) on a sub-6 GHz radio frequency band;
at least one of: discover a capability of at least one of the one or more peer devices for communicating on a 6 GHz radio frequency band or publish a capability of the wireless communication device for communicating on the 6 GHz radio frequency band; and
establish a NAN device link with the at least one peer device on the 6 GHz radio frequency band.

11. The wireless communication device of claim 10, wherein the sub-6 GHz radio frequency band comprises a 2.4 GHz radio frequency band or a 5 GHz radio frequency band.

12. The wireless communication device of claim 10, wherein the processor-readable code, when executed by the at least one processor in conjunction with the at least one modem, is further configured to communicate directly with the at least one peer device over the NAN device link via the 6 GHz radio frequency band without an access point (AP).

13. The wireless communication device of claim 10, wherein the wireless communication device and the one or more peer devices comprise a NAN cluster having synchronized discovery windows.

14. The wireless communication device of claim 10, wherein:
the discovering the capability of the one or more peer devices comprises receiving a NAN service discovery management frame during a NAN discovery window; and
the publishing the capability of the wireless communication device comprises multicasting a NAN service discovery management frame during the NAN discovery window.

15. The wireless communication device of claim 14, wherein:
the discovering the capability of the at least one of the one or more peer devices is via one or more information elements (IEs) in the NAN service discovery management frame; and
the publishing the capability of the wireless communication device is via one or more IEs in the NAN service discovery management frame.

16. The wireless communication device of claim 14, wherein the establishing the NAN device link with the at least one peer device comprises establishing the NAN device link when the wireless communication device publishes the capability of the wireless communication device for communicating on the 6 GHz radio frequency band and discovers the capability of the at least one peer device for communicating on the 6 GHz radio frequency band.

17. The wireless communication device of claim 10, wherein the processor-readable code, when executed by the at least one processor in conjunction with the at least one modem, is further configured to at least one of discover or publish one or more parameters associated with communicating on the 6 GHz radio frequency band.

18. The wireless communication device of claim 17, wherein the one or more parameters comprise at least one of: one or more supported operating classes or one or more supported channel numbers.

19. A mobile station comprising:
at least one modem;
at least one processor communicatively coupled with the at least one modem;
at least one memory communicatively coupled with the at least one processor and storing processor-readable code that, when executed by the at least one processor in conjunction with the at least one modem, is configured to:
discover one or more peer devices in a neighborhood aware network (NAN) on a sub-6 GHz radio frequency band;
at least one of: discover a capability of at least one of the one or more peer devices for communicating on a 6 GHz radio frequency band or publish a capability of the mobile station for communicating on the 6 GHz radio frequency band; and
establish a NAN device link with the at least one peer device on the 6 GHz radio frequency band;
at least one transceiver coupled to the at least one modem;
at least one antenna coupled to the at least one transceiver to wirelessly transmit signals output from the at least one transceiver and to wirelessly receive signals for input into the at least one transceiver; and
a housing that encompasses the at least one modem, the at least one processor, the at least one memory, the at least one transceiver, and at least a portion of the at least one antenna.

20. The mobile station of claim 19, wherein the sub-6 GHz radio frequency band comprises a 2.4 GHz radio frequency band or a 5 GHz radio frequency band.
